(19) United States
(12) Patent Application Publication
(10) Pub. No.: US 2024/0196468 A1
(43) Pub. Date: Jun. 13, 2024

(54) KEEPING A TERMINAL IN A CONNECTED STATE WHILE THE TERMINAL IS AWAY FROM A COMMUNICATION NETWORK

(71) Applicant: Lenovo (Singapore) Pte. Ltd., New Tech Park (SG)

(72) Inventors: Genadi Velev, Darmstadt (DE); Prateek Basu Mallick, Dreieich (DE)

(21) Appl. No.: 18/553,727

(22) PCT Filed: Apr. 1, 2022
(86) PCT No.: PCT/IB2022/053081

§ 371 Date: Oct. 2, 2023

Related U.S. Application Data
(60) Provisional application No. 63/169,702, filed on Apr. 1, 2021.

(51) Int. Cl. H04W 76/25; H04W 76/27; H04W 76/38

(52) U.S. Cl. CPC H04W 76/25; H04W 76/27; H04W 76/38

(57) ABSTRACT

Apparatuses, methods, and systems are disclosed for keeping a user equipment (UE) context during a network leaving procedure. One apparatus includes a processor coupled to a transceiver, the processor and the transceiver configured to cause the apparatus to receive a request from a terminal to leave the communication network; to determine to keep the terminal in a mobility management (MM) Connected state while the terminal is away from the communication network; to identify a leave time for the terminal; and to send, to a second network function, an indication that the terminal is leaving for the determined away time, said indication including an instruction not to release a user plane context of the terminal.

### CROSS-REFERENCE TO RELATED APPLICATIONS

This application claims priority to U.S. Provisional Patent Application No. 63/169,702 entitled “METHOD FOR NETWORK LEAVING PROCEDURE AND KEEPING A TERMINAL CONTEXT IN THE RADIO ACCESS NETWORK” and filed on 1 Apr. 2021 for Genadi Velev and Prateek Basu Mallick, which application is incorporated herein by reference.

### FIELD

The subject matter disclosed herein relates generally to wireless communications and more particularly relates to network leaving procedures and keeping a terminal context in the radio access network.

### BACKGROUND

In certain wireless networks may support Multi-USIM devices. A Multi-USIM device is a User Equipment (“UE”) with multiple Universal Subscriber Identity Modules (“USIMs”), capable of maintaining a separate registered state with a Public Land Mobile Network (“PLMN”) for each USIM at least over Third Generation Partnership Project (“3GPP”) Access. A Multi-USIM device is also referred to herein as a “MUSIM UE.”

### BRIEF SUMMARY

Disclosed are procedures for keeping a terminal context in the radio access network (“RAN”) during a network leaving procedure. Said procedures may be implemented by apparatus, systems, methods, or computer program products.

One method at a core network function includes receiving a request from a terminal to leave the communication network and determining to keep the terminal in a mobility management (“MM”) Connected state while the terminal is away from the communication network. The method includes identifying a leave time for the terminal and sending, to a second network function, an indication that the terminal is leaving the communication network for the determined away time and an instruction not to release a user plane context of the terminal.

One method at a RAN includes receiving assistance information from a first core network function, said assistance information indicating that the terminal is to leave the network for an away time, the assistance information also including a request to keep the terminal in an MM Connected state. The method includes determining a Radio Resource Control (“RRC”) state for the terminal based on the assistance information and sending an RRC message to the terminal, said RRC message indicating the determined RRC state and configuring the terminal to notify the RAN when the terminal returns to the communication network. The method includes sending a response message to the first core network function, said response message indicating that the determined RRC state for the terminal.

One method at a User Equipment (“UE”) includes transmitting a first request to leave the first communication network and receiving a response message from a first network function, said response message comprising an away time and an instruction to keep the terminal in an MM Connected state. The method includes performing communication activity in a second communication network and transmitting a resume message to the first network function, said resume message indicating the terminal has returned to the first communication network.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for keeping a terminal context in the radio access network during a network leaving procedure;

FIG. 2A is a diagram illustrating one embodiment of a multi-USIM device leaving Network-A to perform short activity in Network-B;

FIG. 2B is a diagram illustrating one embodiment of a Third Generation Partnership Project (“3GPP”) New Radio (“NR”) protocol stack;

FIG. 2C is a diagram illustrating one embodiment of a protocol stack of a multi-USIM device;

FIG. 3 is a diagram illustrating one embodiment of signaling flow for UE requesting to leave NW-A and keeping the UE in MM Connected state with an appropriate RRC configuration;

FIG. 4 is a diagram illustrating one embodiment of signaling flow for UE requesting to leave NW-A whereas the MME/AMF determines to keep the UE in MM connected state without RAN impact;

FIG. 5 is a block diagram illustrating one embodiment of a user equipment apparatus that may be used for keeping a terminal context in the radio access network during a network leaving procedure;

FIG. 6 is a block diagram illustrating one embodiment of a network apparatus that may be used for keeping a terminal context in the radio access network during a network leaving procedure;

FIG. 7 is a flowchart diagram illustrating one embodiment of a method for keeping a terminal context in the radio access network during a network leaving procedure;

FIG. 8 is a flowchart diagram illustrating one embodiment of a method for configuring a service gap time for a communication terminal leaving the communication network; and

FIG. 9 is a flowchart diagram illustrating another embodiment of a method for keeping a terminal context in the radio access network during a network leaving procedure.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

### Overview+Problem Statement

Generally, the present disclosure describes systems, methods, and apparatuses for a handling a network leaving (or connection release) request of a MUSIM UE, e.g., with or without paging restrictions. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

One of the new features introduced in 4G communication system (e.g., EPS) the 5G communication system (“5GS”) is the support of Multi-USIM devices. A Multi-USIM device (or also called MUSIM UE) is a UE with multiple USIMs, capable of maintaining a separate registered state with a PLMN for each Universal Subscriber Identity Module (“USIM”) at least over 3GPP Access. The UE with a first USIM (i.e., “USIM-1”) may register/attach to a first network (i.e., “Network-A”) and the UE with a second USIM (“USIM-2”) may register/attach with a second network (“Network-B”). In one embodiment, the Network-A and the Network-B may be the same network.

A MUSIM UE may support one or more of the following MUSIM features: 1) Network Leaving (or connection release) with or without paging restrictions; 2) Paging cause indication; 3) Busy (or reject) paging indication (“RPI”); and/or 4) Alternative UE identifier (“ID”).

Regarding Network Leaving with or without paging restrictions, a MUSIM UE indicates to the network that it is leaving one network, by initiating the Non-Access Stratum (“NAS”) MM procedure (e.g., Service Request, Registration Request procedure, Tracking Area Update (“TAU”) procedure). Alternatively, the MUSIM UE may initiate an Access Stratum (“AS”) RRC procedure with the network. In both cases, the MUSIM UE transmits a message (i.e., of the selected procedure) that includes a leave (or release) request indication. If supported by the UE, the MUSIM UE may also provide Paging Restriction Information (“PRI”) (e.g., together with the leave indication), where the PRI requests the network to restrict paging until the MUSIM UE indicates it is returning. The MUSIM UE may return to the network by initiating the NAS MM procedure (e.g., Service Request procedure, TAU procedure or Registration Request procedure) with the network and including a leave indication. As a result, the network removes any paging restriction.

Regarding the Paging cause indication, the MUSIM UE and the network may support an indication of voice service (i.e., IP Multimedia Subsystem (“IMS”) voice) in the paging message. The AMF in case of CM-IDLE state and the NG-RAN in case of CM-CONNECTED with RRC Inactive state, may determine the voice service based on QoS parameter and optionally the Paging Policy Indicator (“PPI”).

Regarding the RPI, the MUSIM UE may respond to a paging request in a network with an indication to the network that the MUSIM UE decides not to accept the paging request, e.g., in case the MUSIM UE is engaged in an active communication with another network. Together with the RPI, the MUSIM UE may include Paging Restriction Information as described above.

Regarding the Alternative UE ID, to avoid possible paging collision and to guarantee the paging reception from different networks, the MUSIM UE may initiate the mobility Registration update procedure in a network to request the use of an alternative UE ID value in this network. In this case, the MUSIM UE may provide an alternative UE ID value in the mobility Registration Request message. Upon reception of this message, the AMF provides a final alternative UE ID value to the MUSIM UE in the Registration Accept message.

A MUSIM UE may include the “Multi-USIM Mode Indication” to the MME/AMF if it has more than one USIM registered and intends to use Multi-USIM specific features. Based on the received Multi-USIM Mode Indication from the MUSIM UE, the MME/AMF shall indicate to the UE whether the above features are supported or not based on network capability and local network policy configuration, by means of one or more of following indications: voice indication in paging supported, the Reject Paging Feature Supported, Leave Feature Supported during Registration procedure, e.g., as specified in clause 4.2.2.2.2 of 3GPP Technical Specification (“TS”) 23.502.

However, it is unclear from current specification how the UE context can be preserved in the RAN while the MUSIM UE requests leaving with the network (e.g., MME or AMF in NW-A) over the NAS layer. The below described solutions provide procedures and related signaling for keeping a terminal context in the radio access network during a network leaving procedure.

In one procedure, the UE may send request for a leave procedure (e.g., a service gap time) in the Access Stratum (“AS”) to the RAN node. In such case, the RAN node may decide whether to keep the UE in RRC-Connected state or release the UE in RRC-Inactive state or release the UE in RRC-Idle state. If the RAN node determines to keep the UE in RRC-Connected state, the RAN node may stop sending Downlink (“DL”) data and stop assigning Uplink (“UL”) transmission resources during the service gap time. Usually, the service gap time is in order of a few milliseconds. This solution relies on the AS layer signaling and can be described as an “AS-based solution.” Note that the AS-based solution is transparent to the Core Network (“CN”) and to the NAS layer. However, in some sometimes the UE may be configured to perform NAS layer signaling to leave the network and the AS layer solution does not work.

In another procedure, the mobility management function (e.g., MME or AMF) may send assistance information to the RAN comprising an indication that the MUSIM UE wants to leave the network for certain time (e.g., LeaveTime) and that the MME/AMF would like to keep the UE in MM Connected state. The RAN determines the RRC state based on the assistance information from the MME/AMF. Note that the mobility management network function terminating the NAS protocols is assumed to be an MME or an AMF or other mobility management entity (referred to herein as “MME/AMF”).

In an alternative procedure, the MME/AMF informs the session management entities in the CN (e.g., SGW, SMF/UPF) to stop sending DL data to the UE. The user plane entities may buffer the DL data. After the UE resumes the NAS signaling connection, the MME/AMF informs the CN related entities to continue sending the DL data to the UE.

In a further procedure, the above RAN-based solution and NAS-based solution may be combined.

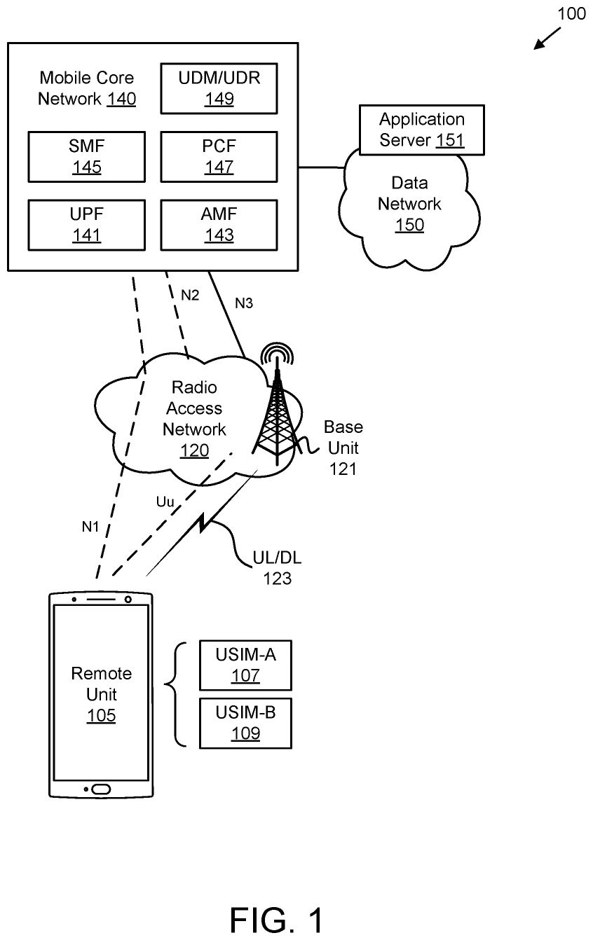

### [FIG. 1—Overall System]

FIG. 1 depicts a wireless communication system 100 for keeping a UE context during a network leaving procedure, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

As depicted, the remote unit 105 includes the USIM-A 107 and the USIM-B 109. For ease of illustration, the USIM-A 107 and USIM-B 109 are depicted as associated with the same PLMN. Moreover, the USIM-A 107 and USIM-B 109 may be associated with the same or different network slices of the same PLMN. In such a situation, the PLMN may interpret the remote unit 105 as two different remote units having each own registration with the network. In other embodiments, the USIM-A 107 and USIM-B 109 may be associated with different PLMNs.

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In some embodiments, the remote units 105 communicate with an application server 151 via a network connection with the mobile core network 140. For example, an application (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for keeping a UE context during a network leaving procedure apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB” is used for the base station/base unit, but it is replaceable by any other radio access node, e.g., RAN node, ng-eNB, eNB, Base Station (“BS”), Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for keeping a UE context during a network leaving procedure.

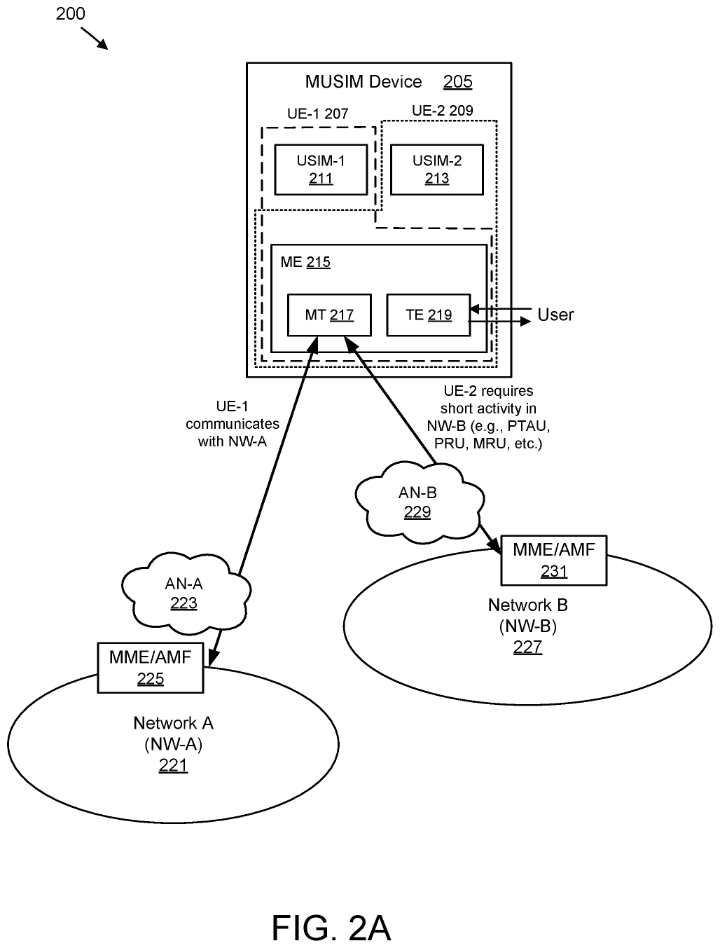

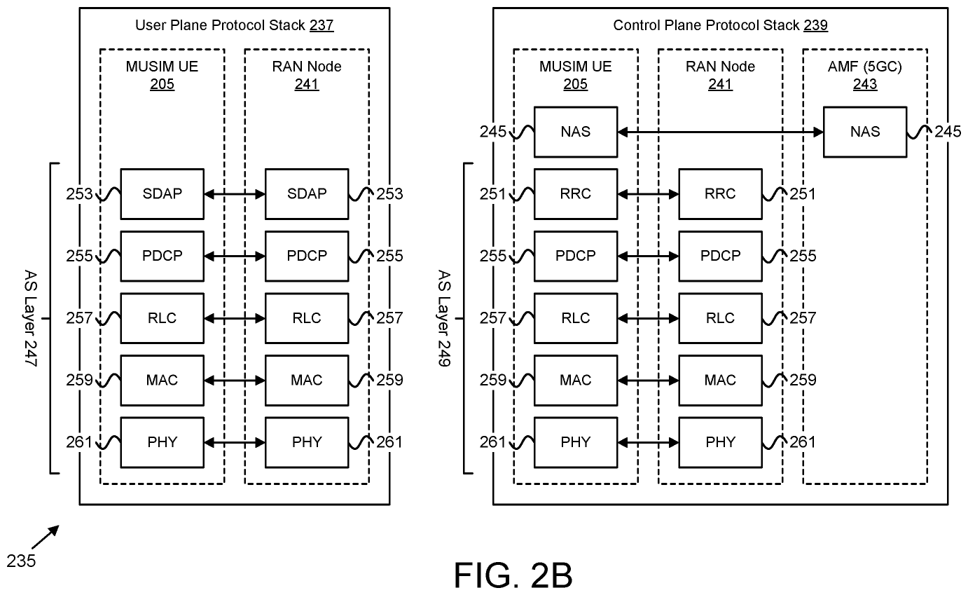

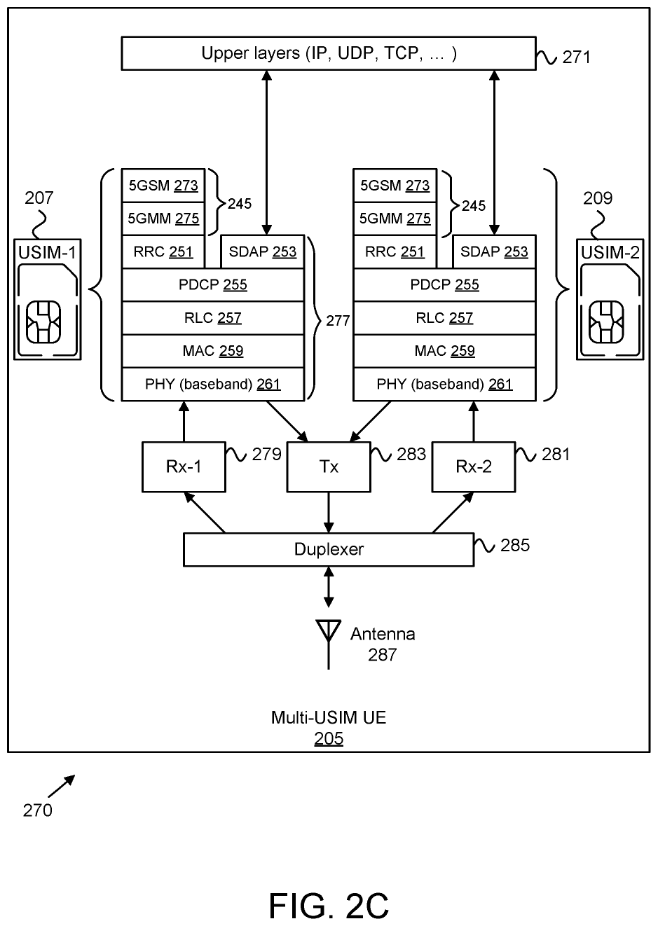

### [FIG. 2A—MUSIM Leaving Scenario]

FIG. 2A depicts a scenario 200 of multi-USIM (“MUSIM”) device 205 leaving Network-A (denoted “NW-A”) 221 to perform short activity in Network-B (denoted “NW-B”) 227, according to embodiments of the disclosure. The MUSIM UE 205 is shown as implementing two user equipment—denoted “UE-1 207” and “UE-2 209”. The UE-1 207 (containing USIM-1 211) is a subscriber of NW-A 221 and the UE-2 209 (containing USIM-2 213) is a subscriber of NW-B 227. Both the UE-1 207 and UE-2 209 access the Mobile Equipment (“ME”) 215, which comprises a Mobile Termination (“MT”) 217 (i.e., a component of the ME 215 performing functions specific to management of the radio interface) and Terminal Equipment (“TE”) 219 (i.e., a component of the ME 215 offering services to the user).

In the depicted embodiment, the UE-2 209 communicates with the MME/AMF 231 in NW-B 227 via the RAN-B 229 (i.e., the Access Network associated with NW-B 227) as the UE-2 209 performs control plane interaction in NW-B 227, i.e., no data transmission over the user plane. The term “network” encompasses a Public Land Mobile Network (“PLMN”), or Standalone Non-Public Network (“SNPN”), or other type of mobile communication network. Note that the NW-A 221 and NW-B 227 may be the same network if the subscription of UE-1 207 and UE-2 209 are from the same network.

The UE-1 207 communicates with NW-A 221 and it is in EMM/CM Connected state. The MUSIM UE 205 is required to perform short activity in NW-B 227. The MUSIM UE 205 (i.e., UE-2 209) is aware that the procedure with NW-B 227 may be for a specific type of communication activity, including (but not limited to) one of the following:

A) mobility tracking area update (“MTAU”) or periodic tracking area update (“PTAU”).

B) mobility registration update (“MRU”) or periodic registration update (“PRU”). Note that the MRU includes a Registration Request (“RR”) message having an indication for mobility registration, while the PRU includes a RR message having an indication for periodic registration.

C) the UE-2 209 may be paged in NW-B 227 and the MUSIM UE 205 may want to respond with busy indication (i.e., a reject paging indication (“RPI”)).

D) the UE-2 209 may want to send a Mobile Originated Short Message Service (“MO-SMS”).

As discussed above, it is unclear from current specification what the network behavior (i.e., of RAN and/or CN) and the UE behavior (i.e., of the MUSIM UE 205) should be for a short leaving from a first network (“NW-A 221”) to a second network (“NW-B 227”). The present inventors recognize that it may be beneficial to not release the UE context in the RAN-A 223 (i.e., the Access Network associated with NW-A 221), so that the services in NW-A 221 can be preserved until the MUSIM UE 205 returns from NW-B 227. However, it is unclear from current specification how the UE context can be preserved in the RAN-A 223 while the MUSIM UE 205 requests leaving with the NW-A 221 (e.g., an MME/AMF 225 in NW-A 221) over the NAS layer.

### [FIG. 2B—NR Protocol Stack]

FIG. 2B depicts a protocol stack 235, according to embodiments of the disclosure. While FIG. 2B shows the MUSIM UE 205, a RAN node 241 (e.g., a gNB) and an AMF 243 in a 5G core network, these are representative of a set of remote units 105 interacting with a base unit 121 and a mobile core network 140. As depicted, the protocol stack 235 comprises a User Plane protocol stack 237 and a Control Plane protocol stack 239. The User Plane protocol stack 237 includes the physical (“PHY”) layer 261, the Medium Access Control (“MAC”) sublayer 259, the Radio Link Control (“RLC”) sublayer 257, a Packet Data Convergence Protocol (“PDCP”) sublayer 255, and Service Data Adaptation Protocol (“SDAP”) layer 253. The Control Plane protocol stack 239 includes the physical layer 261, a MAC sublayer 259, a RLC sublayer 257, and a PDCP sublayer 255. The Control Plane protocol stack 239 also includes a Radio Resource Control (“RRC”) layer 251 and a Non-Access Stratum (“NAS”) layer 245.

The AS layer 247 (also referred to as “AS protocol stack”) for the User Plane protocol stack 237 consists of at least SDAP, PDCP, RLC and MAC sublayers, and the physical layer. The AS layer 249 for the Control Plane protocol stack 239 consists of at least RRC, PDCP, RLC and MAC sublayers, and the physical layer—also referred to as the Layer-1 (“L1”). The Layer-2 (“L2”) is split into the SDAP, PDCP, RLC and MAC sublayers. The Layer-3 (“L3”) includes the RRC sublayer 251 and the NAS layer 245 for the control plane and includes, e.g., an Internet Protocol (“IP”) layer or PDU Layer (not depicted) for the user plane. L1 and L2 are referred to as “lower layers,” while L3 and above (e.g., transport layer, application layer) are referred to as “higher layers” or “upper layers.”

The physical layer 261 offers transport channels to the MAC sublayer 259. The MAC sublayer 259 offers logical channels to the RLC sublayer 257. The RLC sublayer 257 offers RLC channels to the PDCP sublayer 255. The PDCP sublayer 255 offers radio bearers to the SDAP sublayer 253 and/or RRC layer 251. The SDAP sublayer 253 maps QoS flows within a PDU Session to a corresponding Data Radio Bearer over the air interface and the SDAP sublayer interfaces the QoS flows to the 5GC (e.g., to user plane function, UPF). The RRC layer 251 provides for the addition, modification, and release of Carrier Aggregation (“CA”) and/or Dual Connectivity (“DC”). The RRC layer 251 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

The NAS layer 245 is between the MUSIM UE 205 and the AMF 243 in the 5GC. NAS messages are passed transparently through the RAN. The NAS layer 245 is used to manage the establishment of communication sessions and for maintaining continuous communications with the MUSIM UE 205 as it moves between different cells of the RAN. In contrast, the AS layers 247 and 249 are between the MUSIM UE 205 and the RAN (i.e., RAN node 241) and carry information over the wireless portion of the network. While not depicted in FIG. 2B, the IP layer exists above the NAS layer 245, a transport layer exists above the IP layer, and an application layer exists above the transport layer.

The MAC layer 259 is the lowest sublayer in the Layer-2 architecture of the NR protocol stack. Its connection to the PHY layer 261 below is through transport channels, and the connection to the RLC layer 257 above is through logical channels. The MAC layer 259 therefore performs multiplexing and demultiplexing between logical channels and transport channels: the MAC layer 259 in the transmitting side constructs MAC PDUs, known as transport blocks, from MAC Service Data Units (“SDUs”) received through logical channels, and the MAC layer 259 in the receiving side recovers MAC SDUs from MAC PDUs received through transport channels.

The MAC layer 259 provides a data transfer service for the RLC layer 257 through logical channels, which are either control logical channels which carry control data (e.g., RRC signaling) or traffic logical channels which carry user plane data. On the other hand, the data from the MAC layer 259 is exchanged with the physical layer through transport channels, which are classified as downlink or uplink. Data is multiplexed into transport channels depending on how it is transmitted over the air.

The PHY layer 261 is responsible for the actual transmission of data and control information via the air interface, i.e., the PHY Layer 261 carries all information from the MAC transport channels over the air interface on the transmission side. Some of the important functions performed by the PHY layer 261 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 251. The PHY layer 261 performs transmissions based on transmission parameters, such as the modulation scheme, the coding rate (i.e., the modulation and coding scheme (“MCS”)), the number of physical resource blocks etc.

### [FIG. 2C—MUSIM Protocol Stack]

FIG. 2C depicts a protocol stack 270 of the multi-USIM UE 205, according to embodiments of the disclosure. The protocol stack 270 in the user plane includes the upper layers 271 (e.g., IP layer, transport (User Datagram Protocol (“UDP”), Transmission Control Protocol (“TCP”)) layer(s), etc.). The protocol stack 270 in the control plane includes the 5GS Session Management (“5GSM”) sublayer 273 and the 5GS Mobility Management (“5GMM”) sublayer 275, which comprise the NAS layer 245. Recall that the AMF 243, which also includes a NAS layer 245, is the peer-end of a NAS signaling connection with the multi-USIM UE 205. The unified AS layer 277 (also referred to as the “Radio Protocol” of the protocol stack 270) includes the RRC layer 251, the Service Data Adaptation Protocol (“SDAP”) layer 253, the PDCP layer 255, the RLC layer 257, the MAC layer 259, and the PHY layer 261 (baseband). The unified AS layer 277 is shown as common layer for the control plane and the user plane. As noted above, the RAN node 241 includes corresponding AS layers and establishes an AS signaling connection with the multi-USIM UE 205.

Note that the multi-USIM UE 205 (e.g., the ME 215 part of the multi-USIM UE 205), needs to implement at least as many NAS protocol stacks and radio protocol stacks (e.g., abbreviated as NAS/RP stack) as the number of USIMs which can be simultaneously registered with the same or different PLMN. In FIG. 2C, there are two NAS/RP stacks and 2 USIM cards/profiles. In certain embodiments, each NAS/RP stack may have its own receiver (e.g., a first receiver (“Rx-1”) 279 for the USIM-1 211 and a second receiver (“Rx-2”) 281 for the USIM-2 213), but the multi-USIM UE 205 may have a single (shared) transmitter 283. Transmitted and received signals are communicated via the duplexer 285 and antenna 287.

### Solutions

The scenario of FIG. 2A is assumed. Here, the MUSIM UE 205 (e.g., UE-1 207) would like to leave the active communication with a first communication network (i.e., NW-A 221) for a short activity in a second communication network (i.e., NW-B 227). The MUSIM UE 205 (i.e., UE-2 209) is aware that the procedure with NW-B 227 is periodic tracking area update (“PTAU”), periodic tracking area update (“MTAU”), periodic registration update (“PRU”), mobility registration update (“MRU”), Reject Paging Indication (“RPI”), Mobile Originated Short Message Service (“MO-SMS”), or something similar. Such procedures can be characterized as requiring only a short time to be performed and they are procedures between the UE and the control plane in the CN (i.e., they do not require exchange of data over the user plane). It is assumed that the UE-1 207 may be aware of such “short” activity procedure in NW-B 227 and based on this awareness, the UE-1 207 may send a new informational element (e.g., “LeaveTime/Action” indication as described further below) to the NW-A 221. Recall that the NW-A 221 and NW-B 227 may be the same network if the subscription of UE-1 207 and UE-2 209 are from the same network.

The EMM/CM Connected state is a general description meaning EPS Mobility Management (“EMM”) Connected state in MME and UE in 4G/EPS, or Connection management (“CM”) Connected state in the AMF and UE in 5GS. A common term “MM Connected state” is used in this document to describe the Connected state in the NAS layer 245. While the MUSIM UE 205 is in MM Connected state in the NAS layer 245, in the RRC layer the UE may be in RRC Connected or RRC Suspend state in E-UTRA, or in RRC Connected or RRC Inactive state in NR.

To preserve the UE context in the RAN-A 223 while the MUSIM UE 205 requests leaving with the network, the MUSIM UE 205 indicates to the NW-A 221 at least one of: Leaving/Release Request indication, paging restrictions and an intended {leave time and/or leave action} to be performed in the other network. The latter indication is meant as the time duration or the type of procedure (e.g., NAS procedure) to be performed in NW-B 227, which is further referred to herein as a “LeaveTime/Action” indication. Based on the received LeaveTime/Action indication the MME/AMF 225 in the NW-A 221 determines whether to release the S1/N1 connection (i.e., to transfer the UE-1 207 to a MM Idle state) or keep the UE-1 207 in the MM Connected state. If the UE-1 207 is kept in the MM Connected state, then the NW-A 221 may start buffering DL packets and maintain/keep the UE context in RAN-A 223 for the indicated leave time (or another time value derived by the network, e.g., called LeaveTimeGrant).

There are at least two variants how to buffer DL packets and keep a MUSIM UE in MM Connected state: In a first variant (“Variant 1”), the MME/AMF triggers a RAN-based solution by sending assistance information (e.g., leaving procedure assistance information) to the RAN comprising at least LeaveTime/Action parameter. The RAN decides 1) whether to keep the MUSIM UE in RRC Connected state or RRC Inactive/Suspend state or release the RRC Connection and move the MUSIM UE in RRC Idle state; and 2) in case of RRC Connected state to reconfigure the UE correspondingly, e.g., with a service gap time. During the service gap, the RAN releases configured grants configurations of the UE and does not provide any dynamic uplink or downlink (UL/DL) grants during the service gap. During the service gap time the UE does not expect to receive DL data or paging, so that the UE may use the radio transmitter to perform radio procedures (e.g., radio measurements or transmissions) in a different cell or network.

In the second variant (“Variant 2”), the MME/AMF applies a CN-based solution by informing the CN related entities (e.g., SGW, SMF/UPF) to stop sending DL data to the MUSIM UE and the CN entities may buffer the DL data. The MME/AMF sends to the MUSIM UE in the NAS MM response message an indication that the MUSIM UE should keep the MM Connected state during the activity in the NW-B 227. After the MUSIM UE resumes the NAS signaling connection, the MME/AMF informs the CN related entities to continue sending the DL data to the UE.

### [Solution 1: RAN-Based Solution]

According to embodiments of a first solution, the MME/AMF may send assistance information to the RAN comprising an indication that the UE (i.e., MUSIM UE 205) wants to leave the network for certain time (e.g., LeaveTime) and that the MME/AMF would like to keep the UE in MM Connected state. The RAN determines the RRC state based on the assistance information from the MME/AMF. The mobility management network function terminating the NAS protocols is assumed to be an MME or an AMF or other mobility management entity (referred to as “MME/AMF”).

In one example, the RAN may determine to keep the UE in RRC Connected state and reconfigure the UE correspondingly, e.g., with a service gap time. The service gap time may be implicitly or explicitly signaled to the UE. In the former case, the network releases the configured grant configurations of the UE and signals the same to UE, and in addition it may not provide any UL and DL dynamic grants, scheduling to the UE for the period of service gap time. In another example, the RAN may determine to release the RRC Connection and put the UE in RRC Suspend state (in LTE/EPC case) or in RRC Inactive state (in NG-RAN case).

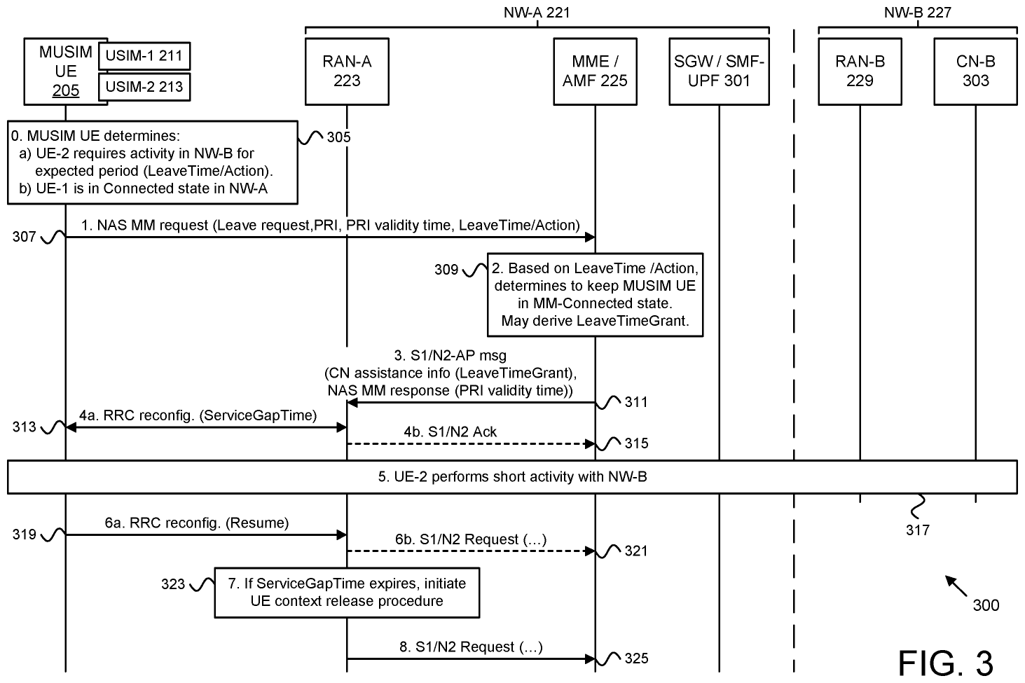

### [FIG. 3]

FIG. 3 depicts a detailed procedure 300 about a UE requesting a first network to release the connection whereas the UE's RAN context is still kept alive in the first network. The procedure 300 may be applicable to 4G/EPS or 5G/5GS or other communication system. The procedure 300 involves the MUSIM UE 205, the NW-A 221, and the NW-B 227. In the depicted embodiments, the NW-A 221 includes the RAN-A 223, the MME/AMF 225, and a session management entity 301, denoted as “SGW/SMF-UPF”, while the NW-B 227 includes the RAN-B 229 and a set of core network function (e.g., including the MME/AMF 231), denoted as “CN-B” 303. The session management network function serving the MUSIM UE 205 is assumed to be an SGW in the case of LTE/EPS or an SMF (and possible UPF interaction) in the case of 5GS.

In EPS, the interface between the MME and RAN (e.g., eNB) is called S1 and the protocol is called S1-AP. In 5GS, the interface between the AMF and RAN (e.g., gNB) is called N2 and the protocol is called NG-AP. In some parts of this document, the S1-AP and NG-AP messages are generalized and referred as “S1/N2” message. In 5GS, the NAS signaling connection between the UE and the AMF is called N1 signaling connection, whereas in EPS there is no specific name for this connection. The detailed description of the procedure 300 is as follows:

At Step 0, the MUSIM UE 205 (i.e., MUSIM device) determines that is needs to perform (short) activity in NW-B 227 while the MUSIM UE 205 is in EMM/CM Connected state (referred to as “MM Connected state”) in NW-A 221 (see block 305). The MUSIM UE 205 determines that the procedure to be performed in NW-B 227 is one of the procedures listed in the problem statement.

The MUSIM UE 205 may determine an expected period for leaving, called LeaveTime based on the procedure to be performed in NW-B 227. For example, the MUSIM UE 205 may determine one of the following values:
The LeaveTime is 200 ms in case of mobility/periodic TAU or mobility registration update (“MRU”) or periodic registration update (“PRU”).
The LeaveTime is 500 ms in case of MO-SMS.
The LeaveTime is 100 ms in case of sending busy indication (or paging reject indication, PRI).

Alternatively, the MUSIM UE 205 may determine the “action” (or type of NAS/communication procedure) to be performed in the other network by UE-2 209.

At Step 1, the MUSIM UE 205 (e.g., UE-1 207) sends NAS MM request message to the MME/AMF 225 in NW-A 221 (see messaging 307). For example, the NAS MM request message can be Service Request message or TAU/RR message. The MUSIM UE 205 may indicate one or more of the following parameters: leaving/release request indication, paging restriction information (“PRI”), PRI validity time, LeaveTime/Action. The leaving/release request indicates that the UE-1 207 wants to leave the network (i.e., NW-A 221) or release the S1/N1 connection. The PRI may indicate to restrict paging until the UE-1 207 indicates it has returned (e.g., as describe in the problem statement). The PRI validity time indicates the time for which the PRI may be applied at network side.

The parameter LeaveTime/Action may indicate one or more of the following: a) the LeaveTime value as determined in step 1; and/or b) the LeaveAction indicates the type of procedure to be performed in the NW-B 227. In case of LeaveAction, the indication may comprise one of the following values MTAU, PTAU, MRU, PRU, RPI, MO-SMS, or other procedure type to be performed in the other network.

For example, in case of LeaveTime indication, the value can be coded as a number expressing e.g., the amount of milliseconds expected for the leaving procedure (e.g., value “500” may mean 500 ms). In case of LeaveAction indication, the value can be coded as a numerical number mapping to a type of procedure, e.g., a value of “01” may be mean MRU/MTAU, a value of “02” may be mean PRU/PTAU, a value of “03” may be mean RPI, a value “04” may be mean MO-SMS, etc.

At Step 2, the MME/AMF 225 determines based on the leave request indication that the UE-1 207 wants to release the S1/N1 connection (see block 309). The LeaveTime/Action indicates either the duration for which the MUSIM UE 205 wants to leave the NW-A 221 (or release S1/N1 connection) or the type of procedure to be performed in the other network (e.g., NW-B 227). The MME/AMF 225 processes the UE request and accepts the request, and in addition, the MME/AMF 225 may determine in which MM state the “release” the UE-1 207. For example, based on LeaveTime/Action, the MME/AMF 225 may determine whether a) to release the S1/N1 connection (i.e., to release the UE-1 207 in MM Idle state) or b) to not release the S1/N1 connection (i.e., to keep the UE's AS context in the RAN-A 223, and thus, to keep the UE-1 207 in MM-Connected state). The MME/AMF 225 may consider also other information when taking this decision, e.g., the type of the established data sessions (e.g., Guaranteed Bit Rate (“GBR”) bearers with certain delay or bit rate requirements), the type of the currently used services, etc. Here, it is assumed that the MME/AMF 225 determines to keep the UE-1 207 of the MUSIM UE 205 in the MM-Connected state.

The MME/AMF 225 may derive NW-A 221 leave time LeaveTimeGrant (e.g., the time for which the UE-1 207 is granted to leave the NW-A 221) which can be the same or similar to the LeaveTime sent from the MUSIM UE 205. Further, the MME/AMF 225 can calculate the LeaveTimeGrant based on the LeaveAction indicated by the MUSIM UE 205. The MME/AMF 225 may use similar calculation time as described in Step 0.

In one of the following example conditions a) the MME/AMF 225 does not support the feature, or b) the MME/AMF 225 is configured by the network to always apply release in MM Idle state when the UE-1 207 is leaving the NW-A 221, or c) the MME/AMF 225 determines based on the LeaveTime/Action to release the UE-1 207 in MM Idle state. It means that the MME/AMF 225 may initiate S1 release (as described in clause 5.3.5 in 3GPP TS 23.401) or AN release procedure (as described in clause 4.2.6 in 3GPP TS 23.502). If the UE-1 207 is released in MM Idle state, the MME/AMF 225 may apply the received LeaveTime indication as validity time for the PRI. In other words, the MME/AMF 225 applies the paging restriction (i.e., not page the UE-1 207 according to the PRI) for the LeaveTime period. After the LeaveTime period expires, the MME/AMF 225 will not apply the PRI, i.e., the MME/AMF 225 would page the UE-1 207 for any Mobile Terminated service.

In other words, the MUSIM UE 205 may send a single leave time indication (e.g., LeaveTime indication only) and the MME/AMF 225 determines to process the leave time indication for multiple purposes. For example, first the MME/AMF 225 may decide (based on the leave time indication) whether to apply release the UE-1 207 to MM Idle state or keep the UE-1 207 in MM Connected state.

At Step 3, the MME/AMF 225 sends S1/N2 request message to the RAN-A 223. The S1/N2 request message contains at least one of MM NAS response (e.g., response to step 1, like NAS Service Accept message), CN assistance information (see messaging 311). The CN assistance information may comprise at least one of: LeaveTimeGrant parameter and/or an indication to keep the UE-1 207 in MM Connected state. The S1/N2 message can use an enhanced existing RRC Inactive Assistance Information IE or a new Information Element (“IE”).

Alternatively, if the MME/AMF 225 in step 2 has decided to release the UE-1 207 in MM Idle state, the S1/N2 request message includes in indication to release the RRC connection (i.e., to transfer the UE in RRC Idle state).

Note that in 4G/EPS, the RRC signaling (in step 4a) may be used as acknowledgement to the step 1, i.e., the AS layer in the UE-1 207 after receiving the RRC signaling (e.g., RRC reconfiguration, RRC release request) informs the NAS layer and this is used as implicit response to step 1. In the 5GS case, the AMF should send NAS Service Accept message (or NAS Service Reject message) as response to step 1.

The MM NAS response message may include a validity time for the PRI (PRI validity time). The MME/AMF 225 may determine the time value for ‘PRI validity time’ to be the same or derived one based on the UE requested LeaveTime or PRI validity time as in step 1.

At Step 4, the RAN node in RAN-A 223 processes the S1/N2 request message. If the S1/N2 message is a request to release the RRC connection is remove the UE context, then the RAN-A 223 follows the request and releases the RRC connection in RRC-Idle state. If the S1/N2 request message indicates that the MME/AMF 225 would like to keep the UE-1 207 in MM Connected state (i.e., the UE-1 207 will be absent for short LeaveTimeGrant period), then the RAN-A 223 determines one of the following cases (and taking the CN assistance information (LeaveTimeGrant) into consideration):

Case #1: To keep the UE-1 207 in RRC-Connected state and assign a ServiceGapTime period to the UE-1 207. The ServiceGapTime may be the same or similar to the LeaveTimeGrant. In step 4a, the ServiceGapTime can be signaled to the UE-1 207 via RRC reconfiguration procedure (see messaging 313). The MUSIM UE 205 (i.e., UE-1 207) will stop requesting UL resource during the time for activity in NW-B 227. The UE-1 207 starts a timer at the AS layer configured with the ServiceGapTime value. During this time, the UL configured grants cannot be used. The RAN-A 223 may configure the MUSIM UE 205 to explicit immediately notify the RAN-A 223 when the MUSIM UE 205 again returns to the NW-A 221, i.e., using UL RRC signaling. This can be helpful in order for the RAN-A 223 to know the reachability of the MUSIM UE 205 in RAN-A 223 and to know whether to terminate/stop the ServiceGapTime timer that may run in the RAN-A 223. In this way the RAN-A 223 will be able to transmit the (buffered) DL data on time and potentially avoid DL packets loss.

After the UE-2 209 has completed the action with NW-B 227, the MUSIM UE 205 returns to NW-A 221 by sending at least one of a dedicated Physical Random Access Channel (“PRACH”), a RRC message or NAS indication that also contains explicit signaling towards RAN-A 223 indicating the UE's return (shown in step 6). In step 4b, the RAN-A 223 sends S1/N2 response message to the MME/AMF 225 as reply to step 3 (see messaging 315). In Case #1, the RAN-A 223 may indicate that the MUSIM UE 205 has been successfully reconfigured with the Leave TimeGrant time and the UE-1 207 is in RRC-Connected state.

Case #2: To release the UE-1 207 in RRC-Suspend state (in case of EPS/E-UTRA access) or in RRC-Inactive state (in case of 5GS/NG-RAN access). In this case, in step 4a the RAN-A 223 sends a RRC release message with the Suspend or Inactive indication and releases the RRC-Connection. In step 4b, the RAN-A 223 sends S1/N2 response message to the MME/AMF 225 indicating that the UE-1 207 is released in RRC-Inactive state.

Case #3: To release the UE-1 207 in RRC-Idle state and remove the UE context in the RAN-A 223. In this case, in step 4a the RAN-A 223 sends RRC release message indicating release to RRC-Idle state. In step 4b, the RAN-A 223 informs the MME/AMF 225 that the RRC connection is released, so that the UE-1 207 transfers to MM Idle state.

In addition, or optionally, the RAN-A 223 decides one of the cases 1), 2) or 3) also taking into consideration the DL buffer status in the RAN-A 223 and/or the UL buffer status in the MUSIM UE 205 (e.g., UE-1 207). For example, if there are GBR bearers (or GBR QoS flows) established or there is DL data buffered, the RAN-A 223 may decide to release the RRC connection, so that the upper layers are aware about the loss of connection. FIG. 3 depicts the RAN-A 223 selecting Case #1.

At Step 5, the MUSIM UE 205 (e.g., UE-2 209) performs the activity with the NW-B 227 (see block 317).

At Step 6a, depending on the RRC state from step 4, the MUSIM UE 205 performs one of the following: if the UE-1 207 is in the RRC-Connected state, then the MUSIM UE 205 performs UL signaling (i.e., as configured in step 4—Case #1). However, if the UE-1 207 is in the RRC-Suspend state or RRC-Inactive state, then the MUSIM UE 205 performs RRC Resume procedure in order to return to RRC Connected state in RAN-A 223 (i.e., as configured in step 4—Case #2). FIG. 3 depicts the RAN-A 223 selecting Case #1 (see messaging 319).

At Step 6b, the RAN-A 223 may optionally send a S1/N2 request or notify message to the MME/AMF 225 indicating that the MUSIM UE 205 has returned to NW-A 221 (see messaging 321). If the MME/AMF 225 has started a leave timer with LeaveTimeGrant (e.g., as per step 2), the indication from the RAN-A 223 would allow the AMF to stop the timer and potentially to inform the SMF to resume the use of the user plane resources.

At Step 7, if the UE-1 207 was kept in the RRC-Connected state and the ServiceGapTime expire, then the RAN-A 223 may perform one of the following: A) Start procedure for Radio Link Failure; and/or B) Initiate UE context release procedure, e.g., S1 release procedure to MME (as described in clause 5.3.5 in 3GPP TS 23.401) or AN Release towards the AMF (as described in clause 4.2.6 in 3GPP TS 23.502). FIG. 3 depicts the scenario where the RAN-A 223 selects Option B (see messaging 323).

At Step 8, the RAN-A 223 sends a S1/N2 request to the MME/AMF 225 to release the UE context (i.e., as described in step 7—Option B; see messaging 325).

The benefit is the solution described in FIG. 3 is that the UE context is kept in the RAN-A 223 while the MUSIM UE 205 is able to perform short activity in NW-B 227. This allows the MUSIM UE 205 to return quickly to NW-A 221 and resume the communication in an efficient way, i.e., there is no need to perform RRC Connection establishment procedure and Service Request procedure which require multiple signaling exchanges and establishment of UE context in RAN-A 223. Specific to this embodiment, the RAN-A 223 has the possibility to re-configure the MUSIM UE (e.g., as per step 4) to save radio resources during the time the MUSIM UE 205 (e.g., UE-1 207) is away from the RAN-A 223.

### [Solution 2: NAS-Layer Solution]

According to embodiments of a second solution, the MME/AMF informs the session management entities in the CN (e.g., SGW, SMF/UPF) to stop sending DL data to the UE. The user plane entities may buffer the DL data. After the UE resumes the NAS signaling connection, the MME/AMF informs the CN related entities to continue sending the DL data to the UE. The mobility management network function terminating the NAS protocols is assumed to be an MME or an AMF or other mobility management entity (referred to as “MME/AMF”).

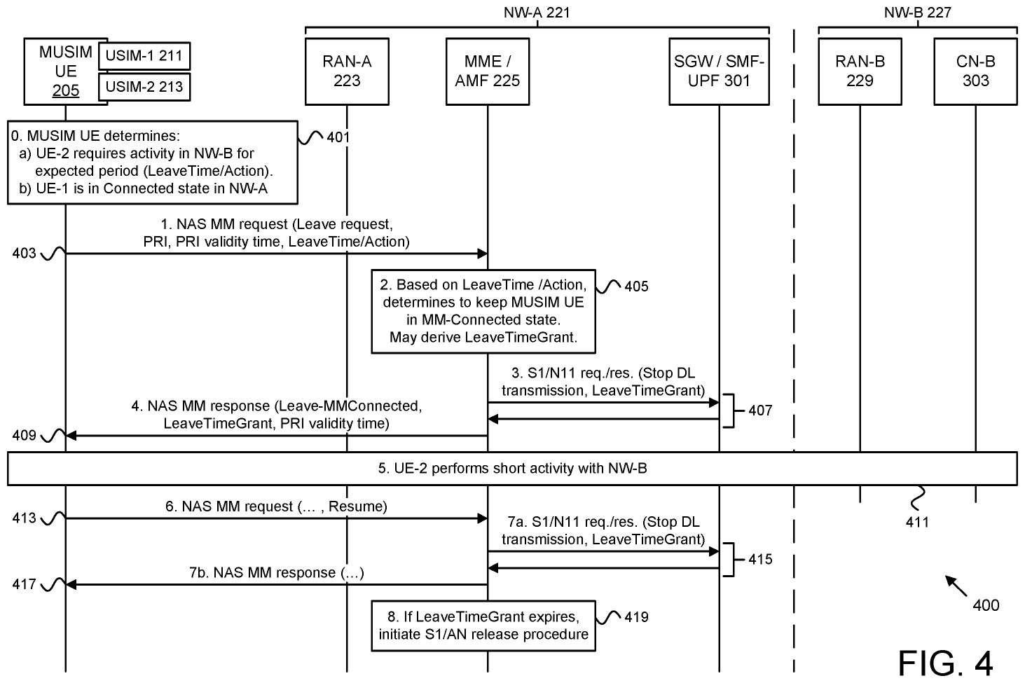

### [FIG. 4]

FIG. 4 shows the signaling flow of the procedure 400 for UE leaving NW-A 221 for short time while keeping the UE in MM Connected state. The signaling is performed in the NAS layer and optionally with session management entities in the CN, but without RAN impact. The procedure 300 involves the MUSIM UE 205, the NW-A 221, and the NW-B 227. In the depicted embodiments, the NW-A 221 includes the RAN-A 223, the MME/AMF 225 and the SGW/SMF-UPF 301, while the NW-B 227 includes the RAN-B 229 and the CN-B 303. The session management entities are shown by the notation “SGW, SMF/UPF” which is a general notion for a) SGW in case of LTE/EPS and b) SMF and possible UPF interaction in case of 5GS.

The detailed description of the procedure 400 is as follows:

Steps 0, 1 and 2 are substantially similar to the steps 0, 1 and 2 described from FIG. 2. Specifically, at Step 0, the MUSIM UE 205 (i.e., MUSIM device) determines that is needs to perform (short) activity in NW-B 227 while the MUSIM UE 205 is in EMM/CM Connected state (referred to as “MM Connected state”) in NW-A 221 (see block 401). The MUSIM UE 205 determines that the procedure to be performed in NW-B 227 is one of the procedures listed in the problem statement.

The MUSIM UE 205 may determine an expected period for leaving, called LeaveTime based on the procedure to be performed in NW-B 227. Alternatively, the MUSIM UE 205 may determine the “action” (or type of NAS/communication procedure) to be performed in the other network by UE-2 209.

At Step 1, the MUSIM UE 205 (e.g., UE-1 207) sends NAS MM request message to the MME/AMF 225 in NW-A 221 (see messaging 403). The MUSIM UE 205 may indicate one or more of the following parameters: leaving/release request indication, paging restriction information (“PRI”), PRI validity time, LeaveTime/Action.

At Step 2, the MME/AMF 225 determines based on the leave request indication that the UE wants to release the S1/N1 connection (see block 405). For example, based on Leave Time/Action, the MME/AMF 225 may determine whether a) to release the S1/N1 connection (i.e., to release the UE-1 207 in MM Idle state) or b) to not release the S1/N1 connection (i.e., to keep the UE's AS context in the RAN-A 223, and thus, to keep the UE-1 207 in MM-Connected state). Here, it is assumed that the MME/AMF 225 determines to keep the UE-1 207 of the MUSIM UE 205 in the MM-Connected state.

The MME/AMF 225 also may derive NW-A 221 leave time LeaveTimeGrant (e.g., the time for which the UE is granted to leave the NW-A 221), as discussed above. For example, the MME/AMF 225 may use similar calculation time as described in Step 0.

At Step 3, it is assumed that in step 2 the MME/AMF 225 has determined to “release” the UE-1 207 in MM Connected state. The MME/AMF 225 determines to apply a NAS-based solution (or CN-based solution), i.e., not telling to the (R)AN about the “release” of the UE-1 207. The MME/AMF 225 sends a S11/N11 request message to the session management entities (e.g., SGW, SMF/UPF) to request a stop of DL data transmission over the user plane (see messaging 407). This indication may be called “Stop DL Transmission indication” and it is sent to the SGW/SMF-UPF 301 to indicate that DL data packets should not be transmitted to the RAN and that the user plane resources of the UE should not be deactivated (or released).

Optionally or alternatively, the MME/AMF 225 may send LeaveTimeGrant period for which the DL data transmission should be avoided. The SGW/SMF-UPF 301 may use this time to determine whether or how long to buffer DL data packets. The MME/AMF 225 may enter a new sub-state of the MM Connected state which may comprise that the UE-1 207 is in MM Connected state with (temporarily) disabled AS transmission (e.g., temporarily unable to receive and transmit signaling and data).

In case of 4G/EPS, the MME may send session update request to the SGW over the S11 interface to request the stop of sending of DL data towards the RAN-A. For example, the MME may send Modify Bearer Request (EPS Bearer Identity, Stop DL Transmission indication). If applicable, the SGW may start to buffer the DL packets.

In case of 5G/5GS, the AMF may send session update request to all SMFs, to which there are activated PDU Sessions, over the N11 interface to request the stop of sending of DL data towards the RAN-A. For example, the AMF may invoke Nsmf_PDUSession_UpdateSMContext (Session Management (“SM”) Context ID, Stop DL Transmission indication). The SMF may reconfigure a corresponding UPF (e.g., packet session anchor (“PSA”) UPF) to stop the DL data transmission and if applicable, to start buffering the DL packets.

The SGW/SMF-UPF 301 replies to the MME/AMF 225 whether the request has been processed successfully or failure has occurred (see messaging 407). If a failure has occurred, or if the SGW/SMF-UPF 301 does not support the feature, the MME/AMF 225 may decide to release the UE-1 207 in MM Idle state, i.e., the MME/AMF 225 may initiate S1 release or AN release procedure.

At Step 4, the MME/AMF 225 sends a NAS MM response message (as reply to step 1) to the MUSIM UE 205 indicating that the MUSIM UE 205 is allowed to leave the NW-A 221 and keep the AS context for the NW-A 221 (see messaging 409). In other words, the UE-1 207 is in MM in Connected state in the NW-A 221 during the time the UE-2 209 performs the (short) action in the NW-B 227. For example, such indication can be called “Leave-MMConnected” parameter. A new MM Connected sub-state may be defined in the MUSIM UE 205 after receiving this indication and the new sub-state is valid until the MUSIM UE 205 resumes the NAS signaling connection in the NW-A 221 (see step 6). This new MM sub-state may comprise that the UE-1 207 is in MM Connected state with (temporarily) disabled AS transmission.

In addition, or optionally, the MME/AMF 225 may send a NAS MM response message to the MUSIM UE 205 containing a time value for which the MME/AMF 225 expects the MUSIM UE 205 to be away from NW-A 221, i.e., the time after which the MUSIM UE 205 is supposed to return back to NW-A 221. This time may be called LeaveTimeGrant. Note that a single indication of LeaveTimeGrant may be enough in the NAS MM message to indicate to the MUSIM UE 205 about the allowance to leave the NW-A 221 and the time value for which is MUSIM UE 205 is expected to be away from NW-A 221.

The NAS MM response message sent to the MUSIM UE 205 may contain at least one of the following new parameters: {Leave-MMConnected, LeaveTimeGrant}.

After the transmission of NAS MM response message, the MME/AMF 225 may start a timer with LeaveTimeGrant value. If the timer expires, then the MME/AMF 225 proceeds with step 8. While the timer is running, the MME/AMF 225 may not send paging to the UE-1 207 or any other Mobile-Terminated signaling. Optionally, if the MUSIM UE 205 indicates PRI in step 1, then the MME/AMF 225 does not send Mobile-Terminated signaling matching to the PRI from step 1.

The NAS MM response message is sent to the RAN-A 223 and from the RAN-A 223 to the MUSIM UE 205 over an RRC transport message. Note, however, that the RAN-A 223 is unaware about the content of the NAS message.

After the MUSIM UE 205 receives the NAS MM response message with indication for Leave-MMConnected and/or LeaveTimeGrant parameter, the NAS layer does not release the NAS MM and NAS SM contexts. The NAS layer instructs the AS layer to stop the transmission and reception of data to/from NW-A 221. The MUSIM UE 205 considers the radio bearers to be in suspended state. Any existing UL data packets buffered in the UL buffer (e.g., PDCP buffer) are kept in the buffer and are not attempted to be transmitted. Alternatively, the MUSIM UE 205 may continue until the current transmissions are finished i.e., retransmissions of the current transmissions are made and/or the L2 buffer is empty. Then the AS layer of the other system/RAT (as part of UE-2 209) is activated, i.e., for transmission and reception for UE-2 209 data and/or signaling. The NAS layer in the MUSIM UE 205 (i.e., UE-1 207) may start a timer with LeaveTimeGrant value.

If there is buffered DL data in RAN-A 223, then the RAN-A 223 may not be able to transmit the DL buffered DL data. It may try re-transmissions and if the RAN-A 223 determines that the MUSIM UE 205 is not reachable, then the RAN-A 223 may start procedure for radio link failure (“RLF”). In other words, the RAN-A 223 is not aware about the UE leaving which has been controlled on the NAS layer.

At Step 5, the MUSIM UE 205 (e.g., UE-2 209) performs the activity with the NW-B 227 (see block 411).

At Step 6, after the MUSIM UE 205 (i.e., UE-2 209) completes the activity in NW-B 227, the MUSIM UE 205 (i.e., UE-1 207) should send a NAS MM request message to the MME/AMF in NW-A 221 in order to indicate that the MUSIM UE 205 is “back” (i.e., the MUSIM UE 205 can resume the communication or resume the NAS signaling connection). For this purpose, the UE-1 207 establishes the RRC connection to RAN-A 223 and transmits the NAS MM request message (see messaging 413).

The NAS MM request message may be a NAS Service Request message, or a Service Request message containing a specific indication for resuming the S1/N1 connection (which case be called “Resume” indication) or another NAS MM message like MTAU or MRU. In principle, any NAS message sent from the MUSIM UE 205 to the MME/AMF 225 after step 4 can be considered by the MME/AMF 225 as an indication to resume the S1/N1 connection, i.e., as an indication that the UE-1 207 returns from the previous release in step 4. It is to be noted that the MUSIM UE 205 (e.g., UE-1 207) should send this NAS MM request message immediately after completing the activity in NW-B 227.

After receiving the NAS MM message, the MME/AMF 225 stops the timer with LeaveTimeGrant value from step 4. The MME/AMF 225 determines that the UE-1 207 resumes the NAS signaling connection.

Note that in one alternative the MUSIM UE 205 may send NAS MM message to request a new leave/release of the S1/N1 connection without a LeaveTime/Action indication and optionally with an indication for paging restrictions. In such case, the MME/AMF 225 may decide to release the UE-1 207 in MM Idle state, i.e., the MME/AMF 225 may initiate S1 release (as described in clause 5.3.5 in 3GPP TS 23.401) or AN release procedure (as described in clause 4.2.6 in 3GPP TS 23.502). If the MUSIM UE 205 is in Connected state in NW-B 227, the MUSIM UE 205 should send a leave request (or S1/N1 release request) in the NW-B 227 in order to perform the new leave/release of the S1/N1 connection without a LeaveTime/Action indication in NW-A 221.

In some aspects, it would be beneficial if the MUSIM UE 205 performs the new leave/release of the S1/N1 connection without a LeaveTime/Action indication in NW-A 221 before the timer with LeaveTimeGrant value expires. This would allow the NW-A 221 to clear the MUSIM UE's AS context in RAN-A 223 and set up the appropriate paging restrictions for Mobile-Terminated services in the session management entities (e.g., SGW/SMF-UPF 301).

At Step 7, the MME/AMF 225 determines to remove the previously requested stop of DL data transmission as per step 3. In other words, the MME/AMF 225 allows the normal data transmission on the user plane.

In step 7a, the MME/AMF sends S11/N11 request message to the session management entities (e.g., SGW, SMF/UPF) to request the transmission data over the user plane (see messaging 415). The SGW/SMF-UPF 301 replies to the MME/AMF 225 whether the request has been processed successfully or failure has occurred.

Similar to step 3, in case of 4G/EPS, the MME may send session update request to the SGW over the S11 interface to request the stop of sending of DL data towards the RAN-A. In case of 5G/5GS, the AMF may send session update request to all SMFs, to which there are activated PDU Sessions, over the N11 interface to request the stop of sending of DL data towards the RAN-A.

In step 7b, the MME/AMF 225 may reply to the MUSIM UE 205 (i.e., reply to step 6) with NAS MM response message used as a confirmation that the NAS signaling connection and data connection are successfully resumed (see messaging 417).

At Step 8, if the MUSIM UE 205 does not return back to NW-A 221 and a timer with LeaveTimeGrant value expires, the MME/AMF 225 may decide to release the UE-1 207 in MM Idle state (see block 419). To release the UE-1 207 in MM Idle state, i.e., the MME/AMF may initiate S1 release (as described in clause 5.3.5 in 3GPP TS 23.401) or AN release procedure (as described in clause 4.2.6 in 3GPP TS 23.502).

As the MUSIM UE 205 (e.g., UE-1 207) may not be reachable over the radio (e.g., Uu) interface, the RAN-A 223 is not able to page the MUSIM UE 205 in order to transmit the RRC release request message. Thus, the RAN-A 223 implicitly deletes the AS context and replies to the MME/AMF 225 that the AS context is released. The UE-1 207 would be in MM Idle state in the MME/AMF 225. The MME/AMF 225 starts applying the PRI, if the MUSIM UE 205 has sent such information during step 1.

On the UE side, if the timer with LeaveTimeGrant value expires in the UE-1 207's NAS layer, the MUSIM UE 205 (e.g., UE-1 207) implicitly determines that on the network side the UE MM context will be transferred to Idle. The MUSIM UE (e.g., UE-1 207) decides to transfer to MM Idle state. The UE-1's NAS layer may indicate to the AS layer to remove the AS context and move the UE to RRC Idle state. All buffered packets are discarded. Additionally, the UE-1 starts MM Idle state procedures.

The benefit is the solution described in FIG. 4 is that the UE context is kept in the RAN-A 223 while the MUSIM UE 205 is able to perform short activity in NW-B 227. Specific to this embodiment, the RAN-A 223 is not impacted and the core network stops sending DL packets for the time the MUSIM UE 205 is away from NW-A 221.

The drawback of the procedure 400 as compared to the procedure 300 is that the RAN-A 223 may have buffered DL packets for the transmission or the MUSIM UE 205 may be in the process of sending UL data when the UE-1 207 “disappears” (i.e., the UE-1 207 is not reachable) for the time of step 5, but the RAN-A 223 will try to re-transmit the DL packets or will schedule the MUSIM UE 205 for UL transmissions. This would result in wasted radio resources.

However, it is considered that the waste of radio resources (e.g., due to re-transmissions) is still much less that the radio resources required to establish the RRC connection (and the UE context in the RAN-A 223) if the MUSIM UE 205 would have been in RRC Idle state.

An MME/AMF may implement mechanism to determine whether to apply the first solution (i.e., the RAN-based solution) or the second solution (i.e., the CN-based, NAS-layer solution). In one example, this determination may be based on the capability of the RAN. For example, during the S1 (e.g., S1-AP) or N2 (e.g., NGAP) association establishment between the RAN node and the MME/AMF, the RAN node may indicate the support of the capability for the RAN-based solution. Then, the MME/AMF may decide to apply the RAN-based solution from the Variant 1 only if the RAN node has previously indicated the support of the capability. If the RAN node has not indicated the support of the capability for the RAN-based solution, then the MME/AMF may decide to apply the CN-based, NAS-layer solution of the Variant 2.

### Solution 3: Combined Solution of RAN-Based and NAS-Layer Solutions

According to the third solution, aspects of the first and second solution may be combined. For the third solution, the following steps may apply:

The MUSIM UE 205 sends a request as per step 1 from FIG. 3. Based on the indicated LeaveTime (or LeaveAction indication), the MME/AMF 225 determines whether to release the UE-1 207 in MM Idle state or keep the UE-1 207 in MM Connected state (as per step 2 from FIG. 3).

If the MME/AMF 225 decides to keep the UE-1 207 in MM Connected state, the MME/AMF 225 determines to send the step 3 from FIG. 3 (i.e., CN assistance information comprise at least one of: LeaveTimeGrant parameter and indication to keep the UE-1 207 in MM Connected state).

After receiving the response message from the RAN node, i.e., step 4b from FIG. 3, based on the response from the RAN-A 223, the MME/AMF 225 determines to perform step 3 from FIG. 4 (e.g., in case that the UE-1 207 is kept in MM Connected state). This would start buffering of DL data packets in the UPF or PGW.

Step 4 from FIG. 4 is not performed.

After the MUSIM UE 205 resumes the connection as per step 6a from FIG. 3, the RAN-A 223 sends S1/N2 request to MME/AMF 225 as per step 6a from FIG. 3. The MME/AMF 225 determines to perform step 7 from FIG. 4 in order to allow the DL data transmission to the RAN-A 223.

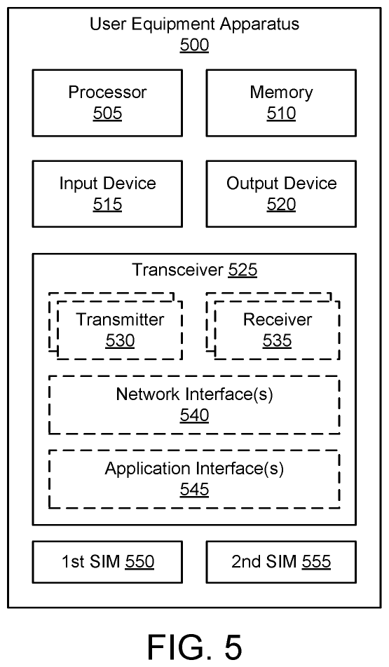

### [FIG. 5—UE Apparatus]

FIG. 5 depicts a user equipment apparatus 500 that may be used for keeping a UE context during a network leaving procedure, according to embodiments of the disclosure. In various embodiments, the user equipment apparatus 500 is used to implement one or more of the solutions described above. The user equipment apparatus 500 may be one embodiment of the remote unit 105, the MUSIM UE 205, and/or the user equipment apparatus 500, described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 121. In various embodiments, the transceiver 525 is operable on unlicensed spectrum. Moreover, the transceiver 525 may include multiple UE panels supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PC5, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user equipment apparatus 500 to implement the above described UE behaviors. In certain embodiments, the processor 505 may include an application processor (also known as “main processor”) which manages application-domain and operating system (“OS”) functions and a baseband processor (also known as “baseband radio processor”) which manages radio functions.

### [UE Behavior]

In various embodiments, the transceiver 525 transmits a first request to leave the first communication network and receives a response message from a first network function, said response message comprising an away time (e.g., ServiceGapTime or LeaveTime) and an instruction to keep the terminal in an MM Connected state. Via the transceiver 525, the processor 505 performs communication activity in a second communication network and transmits a resume message to the first network function, said resume message indicating that the apparatus 500 has returned to the first communication network.

In some embodiments, transmitting the first request message includes transmitting a MM request to a MM function, said MM request including a leave request indication and one or more of: an expected away duration and a type of communication procedure to be performed in another network. In certain embodiments, the MM request further comprises PRI and a PRI validity time.

In some embodiments, the first network function includes a RAN function. In such embodiments, the response message comprises RRC reconfiguration information that indicates a ServiceGapTime parameter indicating the away time and that configures the terminal to immediately notify the RAN function using uplink RRC signaling when the terminal returns to the first communication network.

In some embodiments, the first network function includes a MM function (e.g., an AMF and/or MME). In such embodiments, the response message includes a LeaveTime parameter indicating the away time and a PRI validity time. In certain embodiments, the processor 505 starts a timer with a duration equal to the away time (e.g., in response to receiving the response message) and initiates a procedure to transfer the terminal to an idle mode in response to expiry of the timer.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to keeping a UE context during a network leaving procedure. For example, the memory 510 may store various parameters, panel/beam configurations, resource assignments, policies, and the like as described above. In certain embodiments, the memory 510 also stores program code and related data, such as an operating system or other controller algorithms operating on the apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

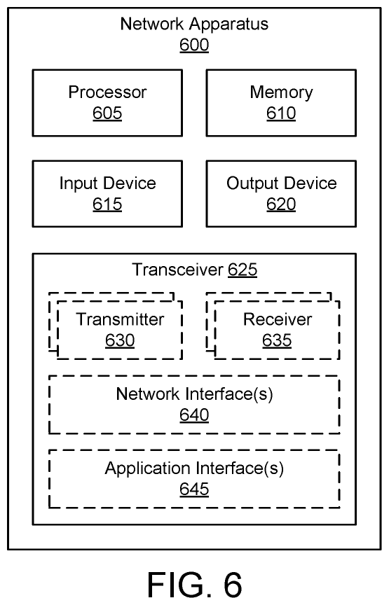

### [FIG. 6—NW/RAN Apparatus]

FIG. 6 depicts a network apparatus 600 that may be used for keeping a UE context during a network leaving procedure, according to embodiments of the disclosure. In one embodiment, network apparatus 600 may be one implementation of a RAN device, such as the base unit 121 and/or RAN node 241, as described above. In another embodiment, the network apparatus 600 may be one implementation of a mobility management function, such as the AMF 143, the MME/AMF 225, the MME/AMF 231, and/or the AMF 243. Furthermore, the network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 65. Additionally, the transceiver 625 may support at least one network interface 640 and/or application interface 645. The application interface(s) 645 may support one or more APIs. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

### [RAN Behavior]

In various embodiments, the network apparatus 600 is a RAN node (e.g., gNB) that communicates with one or more UEs, as described herein. In such embodiments, the processor 605 controls the network apparatus 600 to perform the above described RAN behaviors. When operating as a RAN node, the processor 605 may include an application processor (also known as “main processor”) which manages application-domain and operating system (“OS”) functions and a baseband processor (also known as “baseband radio processor”) which manages radio functions.

In some embodiments, via the transceiver 625, the processor 605 receives assistance information from a first core network function, said assistance information indicating that a communication terminal (e.g., a UE) is to leave the network for an away time (e.g., LeaveTimeGrant period), the assistance information also including a request to keep the communication terminal in an MM Connected state. The processor 605 determines an RRC state for the communication terminal based on the assistance information (e.g., the LeaveTimeGrant period) and controls the transceiver 625 to send an RRC message to the communication terminal, where the RRC message indicates the determined RRC state and configures the communication terminal to notify the RAN when the communication terminal returns to the communication network (e.g., the NW-A 221). Via the transceiver 625, the processor 605 sends a response message to the first core network function, said response message indicating that the determined RRC state for the communication terminal.

In some embodiments, determining the RRC state for the communication terminal includes determining to keep the communication terminal in a RRC connected state. In such embodiments, sending the RRC message to the communication terminal includes sending RRC reconfiguration information to the communication terminal, said RRC reconfiguration information configuring the communication terminal to immediately notify the RAN using uplink RRC signaling when the communication terminal returns to the communication network.

In certain embodiments, the processor 605 further determines a service gap time based on the away time, where the RRC reconfiguration information indicates the service gap time (e.g., using parameter ServiceGapTime). In certain embodiments, the processor 605 initiates a timer in response to sending the RRC reconfiguration information, said timer have a value based on the determined service gap time.

In further embodiments, the transceiver 625 receives an uplink RRC signaling message from the communication terminal prior to expiry of the service gap timer and, in response the uplink RRC signaling message, the processor 605 resumes downlink communication with the communication terminal. In other embodiments, in response to expiry of the timer, the processor 605 initiates a UE context release procedure towards the first core network function.

In some embodiments, determining the RRC state for the communication terminal includes determining to release the communication terminal to a RRC non-connected state (e.g., RRC-Suspend state, RRC-Inactive state, or RRC-Idle state) based on the away time.

### [MME/AMF Behavior]

In various embodiments, the network apparatus 600 comprises a mobility management function, such as the AMF 143, the MME/AMF 225, and/or the AMF 243, that communicates with one or more entities in a mobile communication network (e.g., via a transceiver 625 and/or network interface 640), as described herein. In such embodiments, the processor 605 controls the network apparatus 600 to perform the above described mobility management function behaviors.

In some embodiments, the processor 605 controls the transceiver 625 to receive a request from a communication terminal (e.g., UE) to leave the communication network. The processor 605 determines to keep the communication terminal in an MM Connected state while the communication terminal is away from the communication network and identifies a leave time for the communication terminal. Via the transceiver 625, the processor 605 sends, to a second network function (e.g., access network entity or session management entity), an indication that the communication terminal is leaving for the determined away time, said indication including an instruction not to release a user plane context of the communication terminal (e.g., to maintain the user plane context for the determined away time).

In some embodiments, the request received from the communication terminal includes one or more of: 1) an expected away duration and a 2) type of communication procedure to be performed in another network. In such embodiments, the leave time is identified based on the expected away duration or the type of communication procedure.

In certain embodiments, determining to keep the communication terminal in the MM Connected state while the communication terminal is away from the communication network is based on an expected leave duration corresponding to the expected away duration or type of communication procedure. In some embodiments, the request further comprises PRI and a PRI validity time.

In some embodiments, the second network function is an Access Network (“AN”) function (e.g., eNB or gNB). In such embodiments, sending the indication to the AN function comprises sending assistance information indicating that the communication terminal is leaving the communication network for the determined away time, the assistance information also including a request to keep the communication terminal in the MM Connected state.

In some embodiments, the second network function is a session management entity (e.g., SGW, SMF and/or UPF), where sending the indication to the session management entity includes sending a second request to stop downlink data transmission. In such embodiments, the processor 605 sends a response to the communication terminal (e.g., UE) indicating to keep the MM Connected state.

In certain embodiments, the response further contains a parameter LeaveTimeGrant which indicates the leave time for the communication terminal. In certain embodiments, the transceiver 625 further receives a NAS message with a resume indication from the communication terminal and sends, to the session management entity, a third request to resume downlink data transmission.

In some embodiments, the processor 605 starts a timer with a duration equal to the leave time and initiates a procedure to transfer the communication terminal to an idle mode in response to expiry of the timer.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to keeping a UE context during a network leaving procedure. For example, the memory 610 may store parameters, configurations, resource assignments, policies, and the like, as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein. Similarly, one or more receivers 635 may be used to communicate with network functions in the Public Land Mobile Network (“PLMN”) and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

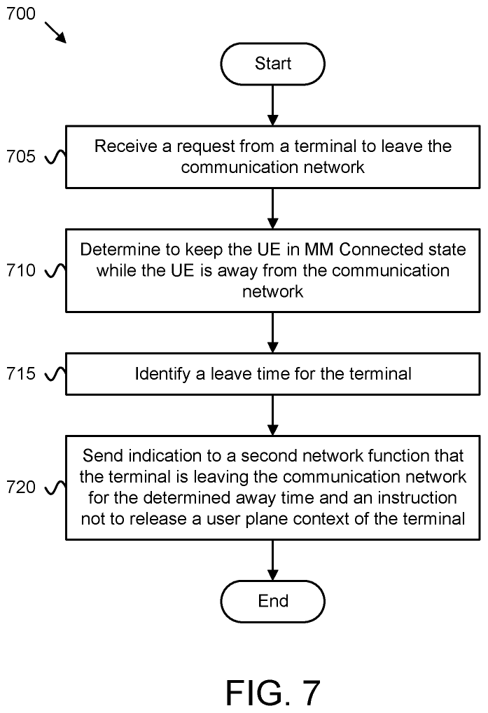

### [FIG. 7—MME/AMF Method]

FIG. 7 depicts one embodiment of a method 700 for keeping a UE context during a network leaving procedure, according to embodiments of the disclosure. In various embodiments, the method 700 is performed by a core network entity (i.e., a mobility management function), such as the AMF 143, the MME/AMF 225, AMF 243, and/or the network apparatus 600, described above as described above. In some embodiments, the method 700 is performed by a processor, such as a microcontroller, a microprocessor, a CPU, a GPU, an auxiliary processing unit, a FPGA, or the like.

The method 700 begins and receives 705 a request from a terminal (e.g., UE) to leave the communication network. The method 700 includes determining 710 to keep the terminal in a MM Connected state while the terminal is away from the communication network. The method 700 includes identifying 715 a leave time for the terminal. The method 700 includes sending 720, to a second network function (e.g., access network entity or session management entity), an indication that the terminal is leaving the communication network for the determined away time and an instruction not to release a user plane context of the terminal. The method 700 ends.

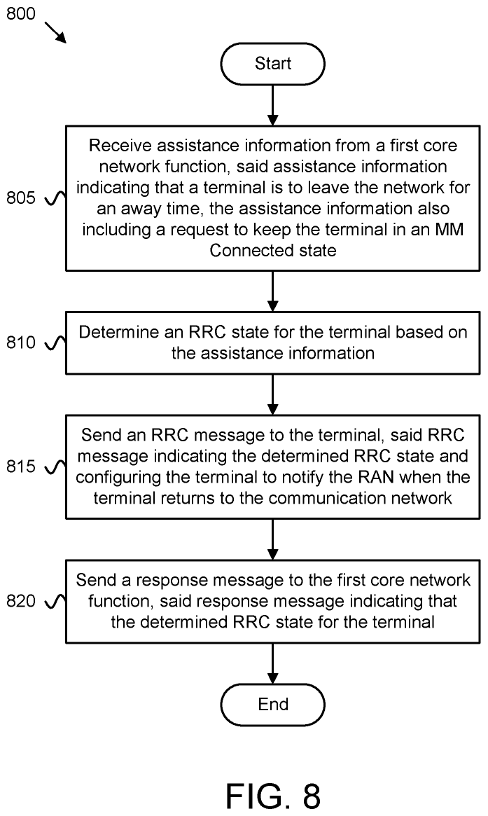

### [FIG. 8—RAN Method]

FIG. 8 depicts one embodiment of a method 800 for configuring a service gap time for a terminal in a communication network, according to embodiments of the disclosure. In various embodiments, the method 800 is performed by an access network node, such as the base unit 121, the RAN node 241, and/or the network apparatus 600, described above as described above. In some embodiments, the method 800 is performed by a processor, such as a microcontroller, a microprocessor, a CPU, a GPU, an auxiliary processing unit, a FPGA, or the like.

The method 800 begins and receives 805 assistance information from a first core network function, said assistance information indicating that a terminal (e.g., UE) is to leave the network for an away time (e.g., LeaveTimeGrant period), the assistance information also including a request to keep the terminal in an MM Connected state. The method 800 includes determining 810 an RRC state for the terminal based on the assistance information (e.g., the LeaveTimeGrant period). The method 800 includes sending 815 an RRC message to the terminal, said RRC message indicating the determined RRC state and configuring the terminal to notify the RAN when the terminal returns to the communication network (e.g., NW-A). The method 800 includes sending 820 a response message to the first core network function, said response message indicating that the determined RRC state for the terminal. The method 800 ends.

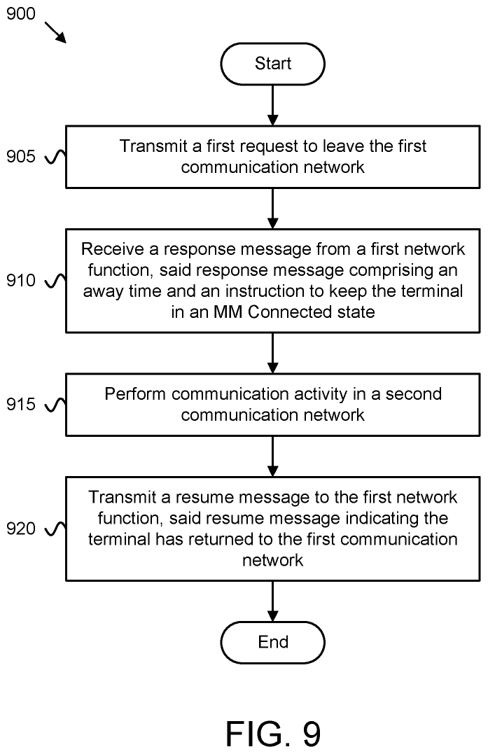

### [FIG. 9—UE Method]

FIG. 9 depicts one embodiment of a method 900 for keeping a UE context during a network leaving procedure, according to embodiments of the disclosure. In various embodiments, the method 900 is performed by a terminal device, such as the remote unit 105, the MUSIM UE 205, and/or the user equipment apparatus 500, described above as described above. In some embodiments, the method 900 is performed by a processor, such as a microcontroller, a microprocessor, a CPU, a GPU, an auxiliary processing unit, a FPGA, or the like.

The method 900 begins and transmits 905 a first request to leave the first communication network. The method 900 includes receiving 910 a response message from a first network function, said response message comprising an away time (e.g., ServiceGapTime or LeaveTime) and an instruction to keep the terminal in an MM Connected state. The method 900 includes performing 915 communication activity in a second communication network. The method 900 includes transmitting 920 a resume message to the first network function, said resume message indicating the terminal has returned to the first communication network. The method 900 ends.

### [Claim Statements]

### [MME/AMF Apparatus]

Disclosed herein is a first apparatus for keeping a UE context during a network leaving procedure, according to embodiments of the disclosure. The first apparatus may be implemented by a core network entity (i.e., a mobility management function), such as the AMF 143, the MME/AMF 225, the AMF 243, and/or the network apparatus 600, described above. The first apparatus includes a processor coupled to a transceiver, the processor and the transceiver configured to cause the first apparatus to receive a request from a terminal (e.g., UE) to leave the communication network; to determine to keep the terminal in an MM Connected state while the terminal is away from the communication network; to identify a leave time for the terminal; and to send, to a second network function (e.g., access network entity or session management entity), an indication that the terminal is leaving for the determined away time, said indication including an instruction not to release a user plane context of the terminal.

In some embodiments, the request received from the terminal includes one or more of: 1) an expected away duration and a 2) type of communication procedure to be performed in another network. In such embodiments, the leave time is identified based on the expected away duration or the type of communication procedure.

In certain embodiments, determining to keep the terminal in the MM Connected state while the terminal is away from the communication network is based on an expected leave duration corresponding to the expected away duration or type of communication procedure.

In some embodiments, the request further includes PRI and a PRI validity time. In some embodiments, the first network function is a mobility management function (e.g., MME or AMF).

In some embodiments, the second network function is an Access Network (“AN”) function (e.g., eNB or gNB). In such embodiments, sending the indication to the AN function includes sending assistance information indicating that the terminal is leaving the communication network for the determined away time, the assistance information also including a request to keep the terminal in the MM Connected state.

In some embodiments, the second network function is a session management entity (e.g., SGW, SMF or UPF), where sending the indication to the session management entity includes sending a second request to stop downlink data transmission. In such embodiments, the processor sends a response to the terminal (e.g., UE) indicating to keep the MM Connected state.

In certain embodiments, the response further contains a parameter LeaveTimeGrant which indicates the leave time for the terminal. In certain embodiments, the transceiver further receives a NAS message with a resume indication from the terminal and sends, to the session management entity, a third request to resume downlink data transmission.

In some embodiments, the processor further starts a timer with a duration equal to the leave time and initiates a procedure to transfer the terminal to an idle mode in response to expiry of the timer.

### [MME/AMF Method]

Disclosed herein is a first method for keeping a UE context during a network leaving procedure, according to embodiments of the disclosure. The first method may be performed by a core network entity (i.e., a mobility management function), such as the AMF 143, the MME/AMF 225, the AMF 243, and/or the network apparatus 600, described above. The first method includes receiving a request from a terminal (e.g., UE) to leave the communication network and determining to keep the terminal in an MM Connected state while the terminal is away from the communication network. The first method includes identifying a leave time for the terminal and sending, to a second network function (e.g., access network entity or session management entity), an indication that the terminal is leaving the communication network for the determined away time and an instruction not to release a user plane context of the terminal.

In some embodiments, the request received from the terminal includes one or more of: 1) an expected away duration and a 2) type of communication procedure to be performed in another network. In such embodiments, the leave time is identified based on the expected away duration or the type of communication procedure.

In certain embodiments, determining to keep the terminal in the MM Connected state while the terminal is away from the communication network is based on an expected leave duration corresponding to the expected away duration or type of communication procedure.

In some embodiments, the request further includes PRI and a PRI validity time. In some embodiments, the first network function is a mobility management function (e.g., MME or AMF).

In some embodiments, the second network function is an Access Network (“AN”) function (e.g., eNB or gNB). In such embodiments, sending the indication to the AN function includes sending assistance information indicating that the terminal is leaving the communication network for the determined away time, the assistance information also including a request to keep the terminal in the MM Connected state.

In some embodiments, the second network function is a session management entity (e.g., SGW, SMF and/or UPF), where sending the indication to the session management entity includes sending a second request to stop downlink data transmission. In such embodiments, the first method also includes sending a response to the terminal (e.g., UE) indicating to keep the MM Connected state.

In certain embodiments, the response further contains a parameter LeaveTimeGrant which indicates the leave time for the terminal. In certain embodiments, the first method further includes receiving a NAS message with a resume indication from the terminal and sending, to the session management entity, a third request to resume downlink data transmission.

In some embodiments, the first method further includes starting a timer with a duration equal to the leave time and initiating a procedure to transfer the terminal to an idle mode in response to expiry of the timer.

### [RAN Apparatus]

Disclosed herein is a second apparatus for configuring a service gap time for a terminal (e.g., a UE) in a communication network (e.g., NW-A), according to embodiments of the disclosure. The second apparatus may be implemented by an access network node, such as the base unit 121, the RAN node 241, and/or the network apparatus 600, described above. The second apparatus includes a processor coupled to a transceiver, the processor and the transceiver configured to cause the second apparatus to receive assistance information from a first core network function, said assistance information indicating that a terminal is to leave the network for an away time (e.g., LeaveTimeGrant period), the assistance information also including a request to keep the terminal in an MM Connected state; to determine an RRC state for the terminal based on the assistance information (e.g., the LeaveTimeGrant period); to send an RRC message to the terminal, said RRC message indicating the determined RRC state and configuring the terminal to notify the RAN when the terminal returns to the communication network; and to send a response message to the first core network function, said response message indicating that the determined RRC state for the terminal.

In some embodiments, determining the RRC state for the terminal includes determining to keep the terminal in a RRC connected state. In such embodiments, sending the RRC message to the terminal includes sending RRC reconfiguration information to the terminal, said RRC reconfiguration information configuring the terminal to immediately notify the RAN using uplink RRC signaling when the terminal returns to the communication network.

In certain embodiments, the processor further determines a service gap time based on the away time, where the RRC reconfiguration information indicates the service gap time (e.g., using parameter ServiceGapTime). In certain embodiments, the processor initiates a timer in response to sending the RRC reconfiguration information, said timer have a value based on the determined service gap time.

In further embodiments, the transceiver receives an uplink RRC signaling message from the terminal prior to expiry of the service gap timer and, in response the uplink RRC signaling message, the processor resumes downlink communication with the terminal. In other embodiments, in response to expiry of the timer, the processor initiates a UE context release procedure towards the first core network function.

In some embodiments, determining the RRC state for the terminal includes determining to release the terminal to a RRC non-connected state (e.g., RRC-Suspend state, RRC-Inactive state, or RRC-Idle state) based on the away time.

### [RAN Method]

Disclosed herein is a second method for configuring a service gap time for a terminal (e.g., a UE) in a communication network (e.g., NW-A), according to embodiments of the disclosure. The second method may be performed by an access network node, such as the base unit 121, the RAN node 241, and/or the network apparatus 600, described above. The second method includes receiving assistance information from a first core network function, said assistance information indicating that the terminal is to leave the network for an away time (e.g., LeaveTimeGrant period), the assistance information also including a request to keep the terminal in an MM Connected state. The second method includes determining an RRC state for the terminal based on the assistance information (e.g., the LeaveTimeGrant period) and sending an RRC message to the terminal, said RRC message indicating the determined RRC state and configuring the terminal to notify the RAN when the terminal returns to the communication network. The second method includes sending a response message to the first core network function, said response message indicating that the determined RRC state for the terminal.

In some embodiments, determining the RRC state for the terminal includes determining to keep the terminal in a RRC connected state. In such embodiments, sending the RRC message to the terminal includes sending RRC reconfiguration information to the terminal, said RRC reconfiguration information configuring the terminal to immediately notify the RAN using uplink RRC signaling when the terminal returns to the communication network.

In certain embodiments, the second method further includes determining a service gap time based on the away time, where the RRC reconfiguration information indicates the service gap time (e.g., parameter ServiceGapTime). In certain embodiments, the second method includes initiating a timer in response to sending the RRC reconfiguration information, said timer have a value based on the determined service gap time.

In further embodiments, the second method includes receiving an uplink RRC signaling message from the terminal prior to expiry of the service gap timer and resuming downlink communication with the terminal in response to receiving the uplink RRC signaling message. In other embodiments, the second method includes initiating a UE context release procedure towards the first core network function in response to expiry of the timer.

In some embodiments, determining the RRC state for the terminal includes determining to release the terminal to a RRC non-connected state (e.g., RRC-Suspend state, RRC-Inactive state, or RRC-Idle state) based on the away time.

### [UE Apparatus]

Disclosed herein is a third apparatus for keeping a UE context during a network leaving procedure, according to embodiments of the disclosure. The third apparatus may be implemented by a terminal device, such as the remote unit 105, the MUSIM UE 205, and/or the user equipment apparatus 500, described above. The third apparatus includes a processor coupled to a transceiver, the processor and the transceiver configured to cause the third apparatus to transmit a first request to leave the first communication network; to receive a response message from a first network function, said response message comprising an away time (e.g., ServiceGapTime or LeaveTime) and an instruction to keep the terminal in an MM Connected state; to perform communication activity in a second communication network; and to transmit a resume message to the first network function, said resume message indicating the third apparatus has returned to the first communication network.

In some embodiments, transmitting the first request message includes transmitting a MM request to a MM function, said MM request including a leave request indication and one or more of: an expected away duration and a type of communication procedure to be performed in another network. In certain embodiments, the MM request further comprises PRI and a PRI validity time.

In some embodiments, the first network function includes a RAN function. In such embodiments, the response message comprises RRC reconfiguration information that indicates a ServiceGapTime parameter indicating the away time and that configures the terminal to immediately notify the RAN function using uplink RRC signaling when the terminal returns to the first communication network.

In some embodiments, the first network function includes a MM function (e.g., an AMF and/or MME). In such embodiments, the response message includes a LeaveTime parameter indicating the away time and a PRI validity time. In certain embodiments, the processor starts a timer with a duration equal to the away time (e.g., in response to receiving the response message) and initiates a procedure to transfer the terminal to an idle mode in response to expiry of the timer.

### [UE Method]

Disclosed herein is a third method for keeping a UE context during a network leaving procedure, according to embodiments of the disclosure. The third method may be performed by a terminal device, such as the remote unit 105, the MUSIM UE 205, and/or the user equipment apparatus 500, described above. The third method includes transmitting a first request to leave the first communication network and receiving a response message from a first network function, said response message comprising an away time (e.g., ServiceGapTime or LeaveTime) and an instruction to keep the terminal in an MM Connected state. The third method includes performing communication activity in a second communication network and transmitting a resume message to the first network function, said resume message indicating the terminal has returned to the first communication network.

In some embodiments, transmitting the first request message includes transmitting a MM request to a MM function, said MM request including a leave request indication and one or more of: an expected away duration and a type of communication procedure to be performed in another network. In certain embodiments, the MM request further comprises PRI and a PRI validity time.

In some embodiments, the first network function includes a RAN function. In such embodiments, the response message comprises RRC reconfiguration information that indicates a ServiceGapTime parameter indicating the away time and that configures the terminal to immediately notify the RAN function using uplink RRC signaling when the terminal returns to the first communication network.

In some embodiments, the first network function includes a MM function (e.g., an AMF and/or MME). In such embodiments, the response message includes a LeaveTime parameter indicating the away time and a PRI validity time. In certain embodiments, the third method further includes starting a timer with a duration equal to the away time (e.g., in response to receiving the response message) and initiating a procedure to transfer the terminal to an idle mode in response to expiry of the timer.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a first core network function in a communication network, the method comprising:
receiving a request from a terminal to leave the communication network;
determining to keep the terminal in a mobility management (“MM”) Connected state while the terminal is away from the communication network;
identifying a leave time for the terminal; and
sending, to a second network function, an indication that the terminal is leaving the communication network for the determined away time and an instruction not to release a user plane context of the terminal.

2. The method of claim 1, wherein the request received from the terminal includes one or more of: an expected away duration and a type of procedure to be performed in another network, wherein the leave time is identified based on the expected away duration or the type of procedure.

3. The method of claim 2, wherein determining to keep the terminal in the MM Connected state while the terminal is away from the communication network is based on an expected leave duration corresponding to the expected away duration or the type of procedure.

4. The method of claim 1, wherein the request further comprises paging restriction information (“PRI”) and a PRI validity time.

5. The method of claim 1, wherein the first network function is a mobility management function.

6. The method of claim 1, wherein the second network function is an access network (“AN”) function, wherein sending the indication to the AN function comprises sending assistance information indicating that the terminal is leaving the communication network for the determined away time, the assistance information also including a request to keep the terminal in the MM Connected state.

7. The method of claim 1, wherein the second network function is a sessions management function, wherein sending the indication to the sessions management function comprises sending a second request to stop downlink data transmission, the method further comprising:
sending a response to the terminal indicating to keep the MM Connected state.

8. The method of claim 7, further comprising:
receiving a NAS message with a resume indication from the terminal; and
sending, to the sessions management function, a third request to resume downlink data transmission.

9. The method of claim 1, further comprising:
starting a timer with a duration equal to the leave time; and
initiating a procedure to transfer the terminal to an idle mode in response to expiry of the timer.

10. A first network apparatus in a communication network, the apparatus comprising:
a transceiver; and
a processor coupled to the transceiver, the processor and the transceiver configured to cause the apparatus to:
receive a request from a terminal to leave the communication network;
determine to keep the terminal in a mobility management (“MM”) Connected state while the terminal is away from the communication network;
identify a leave time for the terminal; and
send, to a second network function, an indication that the terminal is leaving for the determined away time, said indication including an instruction not to release a user plane context of the terminal.

11. A terminal apparatus in a first communication network, the apparatus comprising:
a transceiver; and
a processor coupled to the transceiver, the processor and the transceiver configured to cause the apparatus to:
transmit a first request to leave the first communication network;
receive a response message from a first network function, said response message comprising an away time and an instruction to keep the terminal in a mobility management (“MM”) Connected state;
perform communication activity in a second communication network; and
transmit a resume message to the first network function, said resume message indicating the terminal has returned to the first communication network.

12. The apparatus of claim 11, wherein transmitting the first request message comprises transmitting a mobility management (“MM”) request to a MM function, said MM request comprising a leave request indication and one or more of: an expected away duration and a type of procedure to be performed in another network.

13. The apparatus of claim 12, wherein the MM request further comprises paging restriction information (“PRI”) and a PRI validity time.

14. The apparatus of claim 11, wherein the first network function comprises a RAN function, wherein the response message comprises RRC reconfiguration information indicating a ServiceGapTime parameter indicating the away time and configuring the terminal to immediately notify the RAN function using uplink RRC signaling when the terminal returns to the first communication network.

15. The apparatus of claim 11, wherein the first network function comprises a MM function, wherein the response message comprises a LeaveTime parameter indicating the away time and a Paging Restriction Information (“PRI”) validity time.
